(19) United States
(12) Patent Application Publication
(10) Pub. No.: US 2012/0012521 A1
(43) Pub. Date: Jan. 19, 2012

(54) VINYLIDENE FLUORIDE RESIN HOLLOW FIBER POROUS MEMBRANE AND PROCESS FOR PRODUCING SAME

(76) Inventors: Takeo Takahashi, Tokyo (JP); Yasuhiro Tada, Tokyo (JP); Yasushi Ebihara, Tokyo (JP)

(21) Appl. No.: 13/144,768

(22) PCT Filed: Dec. 24, 2009
(86) PCT No.: PCT/JP2009/071450

§ 371 Date: Sep. 14, 2011

(30) Foreign Application Priority Data
Jan. 15, 2009 (JP) 2009-006941

(51) Int. Cl. B01D 71/34; D01D 5/247

(52) U.S. Cl. 210/500.23; 264/48

(57) ABSTRACT

A hollow-fiber porous membrane of vinylidene fluoride resin, satisfying: a ratio Pmax/Pm of at most 2.0 between a maximum pore size Pmax and an average pore size Pm, and a Pm of 0.13 μm-0.25 μm, according to the half-dry/bubble point method (ASTM F316 and ASTM E1294); a coefficient of variation in outer surface pore size of at most 70%, and a porosity of 75-90%. The hollow-fiber porous membrane has a moderate average pore size, has a pore size distribution which is uniform as a whole and also on the outer surface, and has a high porosity, so that it shows not only a good pure water permeability but also retains a good water permeability even in continuous filtration of cloudy water. The hollow-fiber porous membrane is produced through a process which includes: melt-extruding a vinylidene fluoride resin together with a plasticizer and a good solvent therefor into a hollow-fiber film, cooling and solidifying the film, extracting the plasticizer and good solvent, omitting a heat-treatment for crystallization, and stretching the hollow-fiber after the extraction at a limited temperature range of 80-95° C. which is higher than a conventional stretching temperature.

### TECHNICAL FIELD

The present invention relates to a hollow-fiber porous membrane (a porous membrane in the form of a hollow fiber) made of a vinylidene fluoride resin, which is excellent in water (filtration) treatment performance, and a process for production thereof.

### BACKGROUND ART

Vinylidene fluoride resin is excellent in chemical resistance, heat resistance and mechanical strength and, therefore, has been studied with respect to application thereof to porous membranes for separation. For water (filtration) treatment, particularly for production of potable water or sewage treatment, hollow fiber-form of porous membranes have been used in many cases because of easiness of taking a large membrane area per unit volume of filtration apparatus, and many proposals have been made including processes for production thereof (e.g., Patent documents 1-4 listed below).

Also, the present inventors, et al., have found that a process of melt-extruding a vinylidene fluoride resin having a specific molecular weight characteristic together with a plasticizer and a good solvent for the vinylidene fluoride resin into a hollow fiber-form and then removing the plasticizer by extraction to render the hollow fiber porous is effective for formation of a porous membrane of vinylidene fluoride resin having minute pores of appropriate size and distribution and also excellent in mechanical strength, and have made a series of proposals (Patent documents 5, 6 and others). However, a strong demand exists for further improvements of overall performances including filtration performances and mechanical performances of the hollow-fiber porous membrane necessary for use as a filtration membrane. Particularly, it is desired to provide a pore size distribution which includes a size suitable to remove particles to be removed and is still more uniform. Further, as an MF (microfiltration) membrane used for the purpose of, e.g., production of potable water or industrial water by clarification of river water, etc., or clarification of sewage, it is required to have an average pore size of at most 0.25 μm and a uniform pore size distribution for secure removal of Cryptosporidium as a typical injurious microorganism, and causes little contamination (clogging) with organic substances on the occasion of continuous filtration operation of cloudy water, to maintain a high water permeability. From this viewpoint, a porous membrane proposed by Patent document 4 below has an excessively large average pore size, and a hollow-fiber porous membrane proposed by Patent document 6 retains a problem in maintenance of a water permeability in continuous filtration operation of cloudy water.

[Patent document 1] JP-A 63-296939

[Patent document 2] JP-A 63-296940

[Patent document 3] JP-A 3-215535

[Patent document 4] WO02/070115A

[Patent document 5] WO2004/0881109A

[Patent document 6] WO2007/010832A

### DISCLOSURE OF INVENTION

An object of the present invention is to provide a hollow-fiber porous membrane of vinylidene fluoride resin which has micro-pores giving a size (average pore diameter), a uniform pore size distribution and a high porosity suitable for water (filtration) treatment, and also shows good water-permeation-rate maintenance performance, even when applied to continuous filtration of cloudy water, and also a process for production thereof.

The hollow-fiber porous membrane of vinylidene fluoride resin according to the present invention has been developed to achieve the above-mentioned object, and more specifically, is characterized by comprising a porous membrane of vinylidene fluoride resin in a hollow-fiber form and having a ratio Pmax/Pm of at most 2.0 between a maximum pore size Pmax and an average pore size Pm, and a Pm of 0.13 μm-0.25 μm, according to the half-dry/bubble point method (ASTM F316 and ASTM E1294); a coefficient of variation in outer surface pore size of at most 70%, and a porosity of 75-90%.

As a part of study for achievement of the above-mentioned object, the present inventors made a continuous filtration test (of which the details will be described later) by the MBR (membrane bioreactor) process (more specifically, an activated sludge process assisted by membrane separation) as a practical test for evaluating the performance in continuous filtration of cloudy water, with respect to various hollow-fiber porous membranes of vinylidene fluoride resin including those disclosed in the above-mentioned Patent documents 5 and 6. The evaluation was performed in terms of a critical water permeability (or critical filtration flux) which is defined as a maximum water permeability (or maximum filtration flux) giving a differential pressure rise of at most 0.133 kPa after 2 hours of membrane filtration treatment as a practical evaluation standard of water-permeability maintenance power, and a correlation of the evaluation result with the outer surface properties of the porous membranes based on SEM observation thereof, was investigated. As a result, it has been found that, the hollow-fiber porous membrane of Patent document 6 has a slightly small average pore size Pm and also has a large fluctuation in diameter of pores opening to the outer surface on the water supply side (i.e., outer surface pore size), which results in a lowering in capability of maintaining the water permeability. Thus, the hollow-fiber porous membrane of vinylidene fluoride resin of the present invention defined above, is characterized by uniform pore sizes giving a suitably small average pore size according to the half-dry/bubble point method, a uniform outer surface pore size and also a high porosity.

Further, the present inventors had a knowledge that the fluctuation in outer surface pore size of the hollow-fiber porous membranes obtained in Patent documents 5, 6, etc., was attributable to an excessively large stretching force, because a heat-treatment performed before the stretching (that is performed for increasing the water permeability and improving the strengths) for improving the stretchability increased the crystallinity and rigidity of the hollow-fiber porous film or membrane before the stretching, and further succeeded in solving the problem by omitting the heat treatment before the stretching to reduce the rigidity of the yet-unstretched hollow-fiber and by performing stretching in a temperature range higher than before to reduce the stretching stress. Thus, the process for producing a hollow-fiber porous membrane of vinylidene fluoride resin of the present invention is characterized by stretching a hollow-fiber porous membrane of vinylidene fluoride resin having a Young's modulus of at most 80 MPa under an atmosphere temperature of 80-95° C. to produce the above-mentioned hollow-fiber porous membrane of vinylidene fluoride resin of the present invention.

### BRIEF DESCRIPTION OF THE DRAWINGS

FIG. 1 is a schematic illustration of an apparatus for evaluating water permeability of hollow-fiber porous membranes obtained in Examples and Comparative Examples.

FIG. 2 is a schematic illustration of an apparatus for evaluating critical filtration flux by the MBR process of hollow-fiber porous membranes obtained in Examples and Comparative Examples.

### BEST MODE FOR PRACTICING THE INVENTION

Hereafter, the hollow-fiber porous membrane of vinylidene fluoride resin and the production process thereof of the present invention, will be described along the production process.

(Vinylidene Fluoride Resin)

In the present invention, it is preferred to use a vinylidene fluoride resin having a weight-average molecular weight (Mw) of 200,000-600,000 as a main starting material for membrane. At an Mw of below 200,000, the resultant porous membrane is caused to have a small mechanical strength. On the other hand, if Mw exceeds 600,000, the phase separation structure of the vinylidene fluoride resin and the plasticizer in the obtained membrane becomes excessively fine to result in a lower water permeability when used as a microfiltration membrane. Mw is more preferably 300,000-600,000, because in the present invention, the stretching is particularly performed without a heating treatment for pre-crystallization and at a temperature of at least 80° C. which is higher than heretofore.

(Vinylidene Fluoride Resin)

The vinylidene fluoride resin used in the present invention may be homopolymer of vinylidene fluoride, i.e., polyvinylidene fluoride, or a copolymer of vinylidene fluoride together with a monomer copolymerizable with vinylidene fluoride, or a mixture of these. Examples of the monomer copolymerizable with vinylidene fluoride may include: tetrafluoroethylene, hexafluoropropylene, trifluoroethylene, chlorotrifluoroethylene and vinyl fluoride, which may be used singly or in two or more species. The vinylidene fluoride resin may preferably comprise at least 70 mol % of vinylidene fluoride as the constituent unit. Among these, it is preferred to use homopolymer consisting of 100 mol % of vinylidene fluoride in view of its high mechanical strength.

A vinylidene fluoride resin of a relatively high molecular weight as described above may preferably be obtained by emulsion polymerization or suspension polymerization, particularly preferably by suspension polymerization.

The vinylidene fluoride resin used for forming the porous membrane of the present invention may preferably be a mixture formed by blending 70-98 wt. %, of a vinylidene fluoride resin having a weight-average molecular weight of 1.5×10⁵-6.0×10⁵, as a matrix (or principal)vinylidene fluoride resin, and 2-30 wt. % of a high-molecular weight vinylidene fluoride resin, as a crystallinity modifier, having a molecular weight that is at least 1.8 times that of the matrix vinylidene fluoride resin and at most 1.2×10⁶, so as to provide an elevated crystallization temperature Tc of at least 143° C. which is higher than about 140° C. given by a single vinylidene fluoride resin. By raising Tc in this way, on the occasion of the preferential cooling from the outer surface of the hollow-fiber film formed by the melt-extrusion, it becomes possible to accelerate the solidification of the vinylidene fluoride resin from the inside to the inner surface of which the solidification is liable to be retarded compared with the outer film surface, so that growth of spherical particles can be suppressed. Further, it is effective for suppressing the crystallization of the hollow-fiber membrane during the stretching after the plasticizer, etc., and drying, thereby suppressing the fluctuation in outer surface pore size due to an increase in stretching stress.

A plasticizer and a good solvent for vinylidene fluoride resin are added to the above-mentioned vinylidene fluoride resin, to form a starting composition for formation of the membrane.

(Plasticizer)

As the plasticizer, aliphatic polyesters of a dibasic acid and a glycol may generally be used. Examples thereof may include: adipic acid-based polyesters of, e.g., the adipic acid-propylene glycol type, and the adipic acid-1,3-butylene glycol type; sebacic acid-based polyesters of, e.g., the sebacic acid-propylene glycol type; and azelaic acid-based polyesters of, e.g., the azelaic acid-propylene glycol type, and azelaic acid-1,3-butylene glycol type.

(Good Solvent)

Further, as the good solvent for vinylidene fluoride resin, those capable of dissolving vinylidene fluoride resin in a temperature range of 20-250° C. may be used. Examples thereof may include: N-methyl-pyrrolidone, dimethylformamide, dimethylacetamide, dimethyl sulfoxide, methyl ethyl ketone, acetone, tetrehydrofuran, dioxane, ethyl acetate, propylene carbonate, cyclohexane, methyl isobutyl ketone, dimethyl phthalate, and solvent mixtures of these. N-methylpyrrolidone (NMP) is particularly preferred in view of its stability at high temperatures.

(Composition)

The starting composition for formation of the porous membrane may preferably be obtained by mixing 100 wt. parts of the vinylidene fluoride resin with the plasticizer and the good solvent for vinylidene fluoride resin in a total amount of 100-300 wt. parts, more preferably 140-220 wt. parts, including 10-25 wt. % thereof, more preferably 12.5-22.5 wt. % thereof, of the good solvent.

If the total amount of the plasticizer and the good solvent is too small, the viscosity of the composition at the time of the melt-extrusion becomes excessively large to cause melt-fracture. On the other hand, if too large, the viscosity is excessively lowered to cause collapse of the hollow-fiber extrudate (hollow-fiber collapse).

(Mixing and Melt-Extrusion)

The melt-extrusion composition may be extruded into a hollow-fiber film by extrusion through an annular nozzle at a temperature of generally 140-270° C., preferably 150-200° C. Accordingly, the manners of mixing and melting of the vinylidene fluoride resin, plasticizer and good solvent are arbitrary as far as a uniform mixture in the above-mentioned temperature range can be obtained consequently. According to a preferred embodiment for obtaining such a composition, a twin-screw kneading extruder is used, and the vinylidene fluoride resin (preferably in a mixture of a principal resin and a crystallinity-modifier resin) is supplied from an upstream side of the extruder and a mixture of the plasticizer and the good solvent is supplied at a downstream position to be formed into a uniform mixture until they pass through the extruder and are discharged. The twin-screw extruder may be provided with a plurality of blocks capable of independent temperature control along its longitudinal axis so as to allow appropriate temperature control at respective positions depending on the contents of the materials passing therethrough.

(Cooling)

Then, the melt-extruded hollow-fiber film is cooled preferentially from an outside thereof and solidified by introducing it into a cooling liquid bath. In this instance, if the hollow-fiber film is cooled while an inert gas, such as air or nitrogen, is injected into the hollow part thereof, a hollow-fiber film having an enlarged diameter can be obtained. This is advantageous for obtaining a hollow-fiber porous membrane which is less liable to cause a lowering in water permeation rate per unit area of the membrane even at an increased length of the hollow-fiber membrane (WO2005/03700A). As the cooling liquid, a liquid which is inert (i.e., showing non-solvency and non-reactivity) with respect to vinylidene fluoride resin, is generally used, and preferably water is used. The temperature of the cooling liquid can be chosen from a quite wide temperature range of 0-120° C., but preferably 5-100° C., particularly preferably 5-80° C.

(Extraction)

The cooled and solidified hollow-fiber film is then introduced into an extraction liquid bath to remove the plasticizer and the good solvent therefrom, thereby forming a hollow-fiber membrane. The extraction liquid is not particularly restricted provided that it does not dissolve the vinylidene fluoride resin while dissolving the plasticizer and the good solvent. Suitable examples thereof may include: polar solvents having a boiling point on the order of 30-100° C., inclusive of alcohols, such as methanol and isopropyl alcohol, and chlorinated hydrocarbons, such as dichloromethane and 1,1,1-trichloroethane.

(Drying)

The hollow-fiber porous membrane after the extraction is dried to remove the extraction liquid at a drying temperature of preferably at most 80° C., particularly 50° C. or below, to suppress the increases in crystallinity of the vinylidene fluoride resin during the drying. This is because even a drying time of about 1 minute causes the increase in crystallinity at a temperature exceeding 80° C.

(Stretching)

According to the present invention, the hollow-fiber porous membrane after the extraction and drying in the above-described manner is not subjected to heat-treatment for pre-crystallization but subjected to stretching at a temperature of at least 80° C., preferably 80-95° C., to increase the porosity and pore size and improve the strength and elongation of the hollow-fiber porous membrane. Young's modulus of the hollow-fiber porous membrane after drying and before stretching is suppressed to at most 80 MPa, and is usually in the range of 50-80 MPa. Stretching of a hollow-fiber porous membrane having a Young's modulus exceeding 80 MPa is liable to cause a fluctuation in outer surface pore size due to an excessive stretching stress. A stretching temperature of below 80° C. is similarly liable to cause a fluctuation in outer surface pore size due to an excessive stretching stress. On the other hand, at a stretching temperature exceeding 95° C., an increase in porosity cannot be attained even at a higher stretching ratio. The stretching of a hollow-fiber membrane may preferably be effected as a uniaxial stretching in the longitudinal direction of the hollow-fiber membrane by means of, e.g., a pair of rollers rotating at different circumferential speeds. This is because it has been found that a microscopic texture including a stretched fibril portion and a non-stretched node portion appearing alternately in the stretched direction is preferred for the hollow-fiber porous membrane of vinylidene fluoride resin of the present invention to exhibit a harmony of porosity and strength-elongation characteristic thereof. Such a microscopic texture including a mixture of a stretched fibril portion and a non-stretched node portion, can be confirmed by X-ray diffraction. The stretching ratio may suitably be on the order of 2.0-3.2 times, particularly 2.2-3.0 times. If the stretching ratio is excessively large, the hollow-fiber membrane can be broken at a high liability or is liable to have an increased fluctuation in outer surface pore size.

(Relaxation Treatment)

The hollow-fiber porous membrane of vinylidene fluoride resin obtained through the above-mentioned steps may preferably be subjected to at least one stage, preferably at least two stages, of relaxation or fixed length heat treatment in a non-wetting environment (or medium). The non-wetting environment may be formed of non-wetting liquids having a surface tension (JIS K6768) larger than a wet tension of vinylidene fluoride resin, typically water, or almost all gases including air as a representative. The relaxation may be effected by passing a hollow-fiber porous membrane stretched in advance through the above-mentioned non-wetting, preferably heated environment disposed between an upstream roller and a downstream roller rotating at successively decreasing circumferential speeds. The relaxation percentage determined by (1−(the downstream roller circumferential speed/the upstream roller circumferential speed))×100(%) may preferably be totally 1-50%. A relaxation percentage exceeding 50% is difficult to realize or, even if possible, can only result in a saturation or even a decrease of the effect of increasing the water permeability, while it may somewhat depend on the stretching ratio in the previous step, so that it is not desirable.

The first stage relaxation temperature may preferably be 0-100° C., particularly 50-100° C. The relaxation treatment time may be either short or long as far as a desired relaxation percentage can be accomplished. It is generally on the order of from 5 second to 1 minute but need not be within this range.

A latter stage relaxation treatment temperature may preferably be 80-170° C., particularly 120-160° C., so as to obtain a relaxation percentage of 1-20%.

The effect of the above-mentioned relaxation treatment is an increase in water permeability of the resultant hollow-fiber porous membrane, while substantially retaining a sharp pore size distribution. If the above-mentioned treatment is performed at a fixed length, it becomes a heat-setting after stretching.

(Hollow-Fiber Porous Membrane of Vinylidene Fluoride Resin)

The hollow-fiber porous membrane of vinylidene fluoride resin according to the present invention obtained through the above-mentioned series of steps is characterized by: an average pore size Pm of 0.13-0.25 μm, preferably 0.15-0.20 μm, a ratio Pmax/Pm of 1.0-2.0, particularly 1.5-1.9 between a maximum pore size Pmax and an average pore size Pm, based on the pore size distribution according to the half-dry/bubble point method (ASTM F316 and ASTM E1294); a coefficient of variation in outer surface pore size of 40 to 70%, particularly 40 to 65%, based on an outer surface pore size distribution according to a SEM method; and a high porosity of 75 to 95%. An average pore size Pm below 0.13 μm results in a lowering maintenance of water permeability in continuous filtration of cloudy water. On the other hand, a Pm exceeding 0.25 μm causes a lower capability of removing muddy substance and bacteria. Moreover, a small Pmax/Pm ratio represents a high uniformity of pore size at constriction parts of pores totally present in the hollow-fiber porous membrane of the present invention. Furthermore, a small coefficient of variation in outer surface pore size represents that the pore size distribution of the pores exposed to the outer surface is uniform, and is empirically understood to contribute to an improvement in the water-permeation-rate maintenance in continual filtration of cloudy water. Although the lower limits of the Pmax/Pm ratio and the coefficient of variation in outer surface pore size are not limited, it is generally difficult to obtain a Pmax/Pm ratio below 1.5 and less than 40% of coefficient of variation, in practice. As a result of a high porosity as described above, the pure water permeability F (100 kPa, L=200 mm) of the hollow-fiber porous membrane of the present invention shows a good water permeability of 50-300 m/day as measured by a method described hereinafter. Further, as a result of uniformization of the outer surface pore size described above, the hollow-fiber porous membrane of the present invention shows a critical water permeability of at least 0.6 m/day, more preferably at least 0.7 m/day. Although the upper limit of the critical water permeability is not particularly limited, the realization of a critical water permeability exceeding 1.0 m/day of is difficult.

Incidentally, the measuring methods of the above-mentioned various characteristic values by which the hollow-fiber porous membrane of the present invention is characterized and other characteristics values, are inclusively described herein-after.

Other general features of hollow-fiber porous membranes obtained according to the present invention may include: a porosity of 75-85%, preferably 75-80%; an average pore size Ps on the outer surface of 0.20-0.40 μm, preferably 0.25-0.35 μm; a ratio Ps/Pm between an average outer surface pore size Ps and an average pore size Pm by the half-dry/bubble point method of 1.0-1.7, preferably 1.0-1.6; and a pure water permeability F (100 kPa, L=200 mm) of preferably 60 to 200 m/day, a tensile strength of at least 6 MPa, and an elongation at break of at least 5%. Moreover, the thickness is usually in the range of about 50-800 μm, preferably 50-600 μm, particularly preferably 150-500 μm. The outer diameter in the form of a hollow fiber is about 0.3-3 mm, particularly about 1-3 mm. Moreover, substantially no residual inorganic fine powder is contained.

### EXAMPLES

Hereinbelow, the present invention will be described more specifically based on Examples and Comparative Examples. The properties described herein including those described below are based on measured values according to the following methods.

(Weight-Average Molecular Weight (Mw))

A GPC apparatus (“GPC-900”, made by Nippon Bunko K.K.) was used together with a column of “Shodex KD-806M” and a pre-column of “Shodex KD-G” (respectively made by Showa Denko K.K.), and measurement according to GPC (gel permeation chromatography) was performed by using NMP as the solvent at a flow rate of 10 ml/min. at a temperature of 40° C. to measure polystyrene-based molecular weights.

(Crystallization Temperature Tc)

A differential scanning calorimeter “DSC-7” (made by Perkin-Elmer Corp.) was used. A sample resin of 10 mg was set in a measurement cell, and in a nitrogen gas atmosphere, once heated from 30° C. up to 250° C. at a temperature-raising rate of 10° C./min., then held at 250° C. for 1 min. and cooled from 250° C. down to 30° C. at a temperature-lowering rate of 10° C./min., thereby to obtain a DSC curve. On the DSC curve, an exothermic peak temperature in the course of cooling was determined as a crystallization temperature Tc(° C.).

(Porosity)

The length and also the outer diameter and inner diameter of a sample hollow-fiber porous membrane were measured to calculate an apparent volume V (cm³) of the porous membrane, and the weight W (g) of the porous membrane was measured to calculate a porosity according to the following formula:

Porosity(%)=(1−W/(V×ρ))×100,

wherein p: density of PVDF (=1.78 g/cm³).

(Water Permeability)

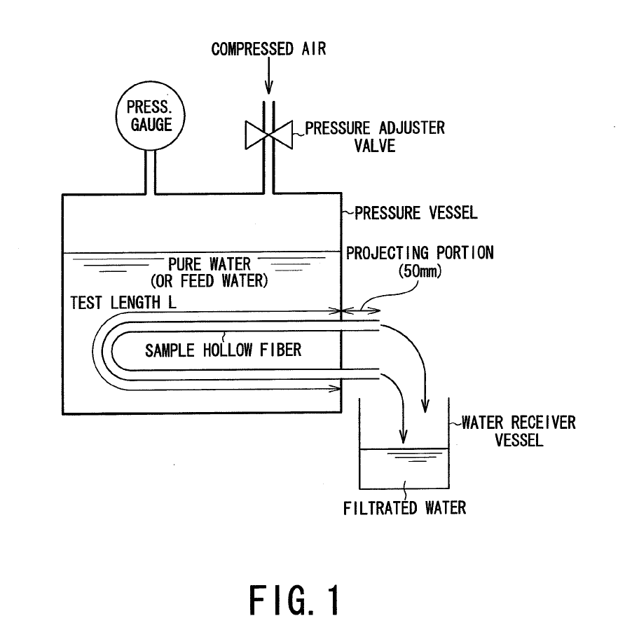

A sample hollow-fiber porous membrane having a test length L (as shown in FIG. 1)=200 mm was immersed in ethanol for 15 min., then immersed in water to be hydrophilized, and then subjected to a measurement of water permeation rate per day (m³/day) at a water temperature of 25° C. and a pressure difference of 100 kPa, which was then divided by a membrane area of the hollow-fiber porous membrane (m²) (=outer diameter×n×test length L) to provide a water permeability. The resultant value is indicated, e.g., as F (100 kPa, L=200 mm), in the unit of m/day (=m³/m²·day).

Further, a water permeability F (100 kPa, L=200 mm) measured at a test length L=200 mm was normalized at a porosity v=70% to obtain F (L=200 mm, v=70%) according to the following formula:

F(L=200 mm, v=70%)=F(100 kPa, L=200 mm)×(70(%)/v(%)).

(Half-Dry/Bubble Point Method)

The half-dry/bubble point method is a method or methods according to ASTM•F316-86 and ASTM•E1294-89 for measuring a maximum pore size Pmax and a pore size distribution with respect to throats of pores in a porous membrane, particularly suited for a hollow-fiber porous membrane. More specifically, according to the bubble point method, a compressed air is supplied into a sample hollow-fiber porous membrane soaked in a test liquid at gradually increasing pressures to determine an air pressure at which a first bubble is generated in the test liquid, and a maximum pore size Pmax (μm) of the sample membrane is calculated from the air pressure. According to the half dry method, an air pressure is determined for a sample hollow-fiber porous membrane at an intersection of a wet flow curve as a flow curve obtained in the state of the sample membrane being wetted with the test liquid and a half dry curve which is defined as a line having a slope of half inclination with respect to a dry flow curve measured in a dry state of the sample membrane, and an average pore size Pm (μm) is calculated from the air pressure. These values described herein are based on values measured by using “PALM POROMTER CFP-2000AEX” made by Porous Materials, Inc., as a measuring instrument and perfluoropolyester (trade name: “GALWICK”) as a test liquid. Hollow-fiber membranes having a test length of ca. 10 mm are ordinarily used as samples.

(Outer Surface Pore Size Distribution by Scanning Electron Microscope (SEM) Observation)

Outer surface pore sizes are measured by a scanning electron microscope (SEM). An external surface (an outer side external surface or an inner side external surface) of a hollow-fiber porous-membrane sample, is photographed at an accelerating voltage of 3 kV and a measurement magnification of 5000 times through a scanning electron microscope (“S-800”, made by Hitachi, Ltd.). Next, each SEM photograph is subjected to measurement of pore sizes with respect to all recognizable pores. A major axis and a minor axis are measured for each pore, and each pore size is calculated according to a formula of: pore size=(major-axis+minor axis)/2. From the acquired pore size distribution, an outer surface average pore size Ps, a standard deviation SD and a coefficient of variation CV (%), were calculated from formulae (1)-(3) shown below:

Ps=ΣnᵢDi/Σnᵢ (1),

wherein Σnᵢ=N (: number of measuring pores),

$$\begin{matrix}\begin{matrix}S D = {( ( 1 / N ) Σ {{n}_{i} ( {D}_{i} - Ps )}^{2} )}^{1 / 2} \\ = {( ( 1 / N ) Σ {n}_{i} {D}_{i}^{2} - {Ps}^{2} )}^{1 / 2} ,\end{matrix} \\ and & ( 2 ) \\ CV ( \% ) = ( SD / Ps ) \times 100. & ( 3 )\end{matrix}$$

(Young's Modulus of Hollow-Fiber Before Stretching)

A hollow fiber after extraction and drying and before stretching was subjected to measurement of a Young's modulus by means of a tensile tester (“RTM-100”, made by Toyo Baldwin K.K.) in an atmosphere of a temperature of 23° C. and 50% of relative humidity, under the conditions including an initial sample length of 100 mm and a crosshead speed of 200 mm/min.

(Critical Water Permeability According to the MBR Process)

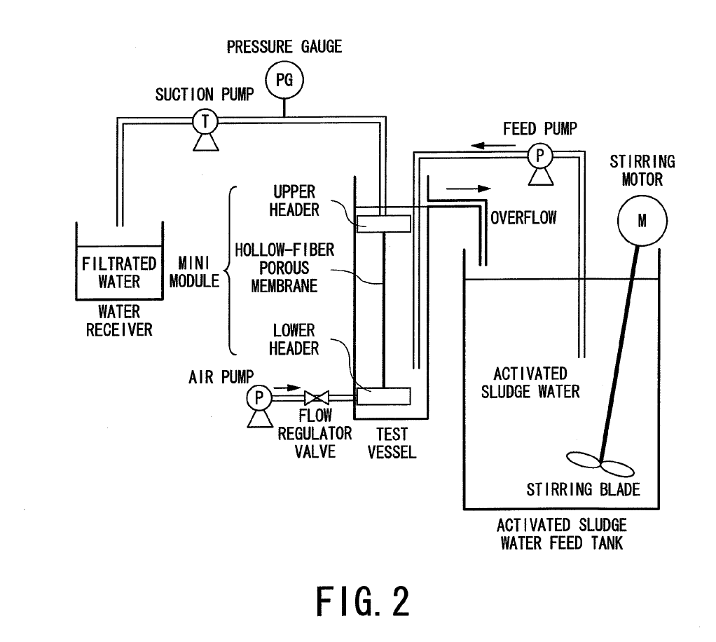

Measured by using an apparatus shown in FIG. 2. More specifically, a single line of hollow-fiber membrane cut off in a length of 500 mm was fixed with an epoxy resin adhesive between stainless steel-made fixing means (an upper header and a lower header) to prepare a module for measurement. The module including the hollow-fiber membrane sample was immersed, then rinsed with pure water, and then immersed at an almost central part within a rectangular test water vessel measuring a bottom area of about 30 cm² and retaining a water level of 600 mm therein, so that the hollow-fiber membrane sample was held vertical. On the other hand, to the test water vessel, an activated sludge water or slurry containing MLSS (mixed liquor suspended solids) of 8600 mg/L and a TOC (total organic content) after filtration with 1-μm glass filter) of 7-9 mg/L accommodated in a feed water tank with an internal volume of 20 L, was supplied at a rate of 0.2 L/with a pump, and circulated back to the feed water tank. Further, from the lower header, air was supplied at a rate of 5 L/min. to cause continual bubbling in the activated sludge water in the test vessel.

In this state, by sucking from the upper end of the hollow-fiber membrane sample in the module, a suction filtration operation was performed for 2 hours while repeating operation cycles each including 13 minute of a suction filtration operation from the exterior to the inside of the hollow-fiber membranes at a fixed filtration water rate and 2 minute of a pause period, thereby measuring changes in pressure difference between the outside and the inside of the hollow-fiber membranes. The filtration test was continued at a fixed filtration water rate, which was initially set at 0.3 m/day as filtration flux (m/day) and was thereafter increased every 2 hours by an increment of 0.1 m/day, until the difference pressure increase rate exceeded 0.133 kPa/2 hours. If the difference pressure increase rate exceeded 0.133 kPa/2 hours in a cycle, a water permeability (that is lower by 0.1 m/day than that in the cycle) was recorded as a critical water permeability (m/day).

### Example 1

A principal vinylidene fluoride resin (PVDF) (powder) having a weight-average molecular weight (Mw) of 4.12×10⁵ and a crystallinity-modifier vinylidene fluoride resin (PVDF) (powder) having Mw=9.36×10⁵ were blended in proportions of 95 wt. % and 5 wt. %, respectively, by a Henschel mixer to obtain Mixture A having Mw=4.38×10⁵.

An adipic acid-based polyester plasticizer (“PN-150”, made by Asahi Denka Kogyo K.K.) as an aliphatic polyester and N-methyl-pyrrolidone (NMP) as a solvent were mixed under stirring in a ratio of 82.5 wt. %/17.5 wt. % at room temperature to obtain Mixture B.

An equi-directional rotation and engagement-type twin-screw extruder (“BT-30”, made by Plastic Kogaku Kenkyusyo K.K.; screw diameter: 30 mm, L/D=48) was used, and Mixture A was supplied from a powder supply port at a position of 80 mm from the upstream end of the cylinder and Mixture B heated to 160° C. was supplied from a liquid supply port at a position of 480 mm from the upstream end of the cylinder at a ratio of Mixture A/Mixture B=34.4/65.6 (wt. %), followed by kneading at a barrel temperature of 220° C. to extrude the melt-kneaded product through a nozzle having an annular slit of 7 mm in outer diameter and 5 mm in inner diameter into a hollow fiber-form extrudate at a rate of 10.1 g/min. In this instance, air was injected into a hollow part of the fiber at a rate of 4.7 mL/min. through an air supply port provided at a center of the nozzle.

The extruded mixture in a molten state was introduced into a cooling bath of water maintained at 70° C. and having a surface 280 mm distant from the nozzle (i.e., an air gap of 280 mm) to be cooled and solidified (at a residence time in the cooling bath of about 3 sec.), pulled up at a take-up speed of 4.0 m/min. and wound up about a reel of about 1 m in diameter to obtain a first intermediate form.

Then, the first intermediate form was immersed under vibration in dichloromethane at room temperature for 30 min., followed by immersion in fresh dichloromethane again under the same conditions to extract the plasticizer and solvent and further by heating for 3 hours at 30° C. and for 1 hour at 50° C. in an oven for removal of the dichloromethane, thereby to obtain a second intermediate form.

Then, the second intermediate form was longitudinally stretched at a ratio of 2.4 times by passing it along a first roller at a speed of 20.0 m/min., through a water bath at 85° C. and along a second roller at a speed of 48.0 m/min. Then, the intermediate form was caused to pass through a bath of warm water controlled at 90° C. and along a third roller at a decreased speed of 42.7 m/min. to effect 1% of relaxation in the warm water bath. Then, the product was wound up to provide a polyvinylidene fluoride-based hollow-fiber porous membrane (a third form) according to the process of the present invention.

The production conditions and physical properties of the thus-obtained polyvinylidene fluoride-based hollow-fiber porous membrane are inclusively shown in Table 1 appearing hereinafter together with the results of Examples and Comparative Examples described below.

### Example 2

A hollow-fiber porous membrane was obtained in the same manner as in Example 1 except for increasing the stretching ratio of the second intermediate form from 2.4 times to 2.8 times.

### Example 3

A hollow-fiber porous membrane was obtained in the same manner as in Example 1 except for changing the water bath temperature to 55° C.

### Example 4

A hollow-fiber porous membrane was obtained in the same manner as in Example 3 except for increasing the stretching ratio of the second intermediate form from 2.4 times to 2.8 times.

### Example 5

A hollow-fiber porous membrane was obtained in the same manner as in Example 2 except for changing the supply ratio of Mixture A/Mixture B to 37.4/62.6 (wt. %) and the water bath temperature to 65° C., respectively.

### Example 6

A hollow-fiber porous membrane was obtained in the same manner as in Example 5 except for increasing the stretching ratio of the second intermediate form from 2.8 times to 3.0 times.

### Comparative Example 1

A hollow-fiber porous membrane was obtained in the same manner as in Example 1 except for changing the stretching temperature to 65° C.

### Comparative Example 2

A hollow-fiber porous membrane was obtained in the same manner as in Example 1 except for changing the heating conditions for removal of dichloromethane after extraction with dichloromethane to 120° C. and 1 hour exerting a heat treatment effect to obtain a second intermediate form, changing the stretching temperature thereof to 65° C., and changing the first step relaxation rate after stretching to 17%.

### Comparative Example 3

A hollow-fiber porous membrane was obtained in the same manner as in Comparative Example 1 except for changing the supply ratio of mixture A/mixture B to 35.7/64.3 (wt. %), the water bath temperature to 40° C., the take-up speed to 11.0 m/min., the stretching conditions to 60° C. and 1.5 times, the first-step relaxation rate after the stretching to 8%, and the second step relaxation rate to 4%, respectively

### Comparative Example 4

A hollow-fiber porous membrane was obtained in the same manner as in Example 4 of Patent document 6.

More specifically, a hollow-fiber porous membrane was obtained in the same manner as in the above-described Example 1 except for changing the plasticizer/solvent ratio in Mixture B to 72.5/27.5 (wt. %), the supply ratio of Mixture A/Mixture B to 35.7/64.3 (wt. %), the water bath temperature to 48° C., the take-up speed to 10.0 m/min., the heating conditions after extraction to 120° C. and 1 hour exerting a heat treatment effect, the stretching conditions to 60° C. and 2.2 times, the first-step relaxation conditions after stretching to a relaxation rate of 5% in dichloromethane at a temperature of 5° C., and the second-step relaxation rate to 5%, respectively.

The production conditions and the physical properties of the resultant hollow-fiber porous membranes of the above-described Examples and Comparative Examples, are inclusively summarized in the following Table 1.

TABLE 1

| | | Example | 1 | 2 | 3 | 4 | 5 |
|---|---|---|---|---|---|---|---|
| Starting | Mixture A | Mw of principal PVDF (×105) | 4.12 | 4.12 | 4.12 | 4.12 | 4.12 |
| material | | Mw of crystallinity-modifier PVDF (×105) | 9.36 | 9.36 | 9.36 | 9.36 | 9.36 |
| | | Mix. ratio (wt. %) | 95/5 | 95/5 | 95/5 | 95/5 | 95/5 |
| | | Mw of Mixture A (×105) | 4.38 | 4.38 | 4.38 | 4.38 | 4.38 |
| | Mixture B | Polyester plasticizer | PN150 | PN150 | PN150 | PN150 | PN150 |
| | | Solvent | NMP | NMP | NMP | NMP | NMP |
| | | Plasticizer/solvent Mix. ratio (wt. %) | 82.5/17.5 | 82.5/17.5 | 82.5/17.5 | 82.5/17.5 | 82.5/17.5 |
| | Mix. ratio | Mixture A/Mixture B (by weight ) | 34.4/65.6 | 34.4/65.6 | 34.4/65.6 | 34.4/65.6 | 37.4/62.6 |
| | Compo- | PVDF | 34.4 | 34.4 | 34.4 | 34.4 | 37.4 |
| | sition (%) | Polyester plasticizer | 54.1 | 54.1 | 54.1 | 54.1 | 51.6 |
| | | Solvent | 11.5 | 11.5 | 11.5 | 11.5 | 11.0 |
| Production | | Water bath temperature (° C.) | 70 | 70 | 55 | 55 | 65 |
| conditions | | Take-up speed (m/min) | 4.0 | 4.0 | 4.0 | 4.0 | 4.0 |
| | | Pre-stretching heat treatment | None | None | None | None | None |
| | | Stretching temperature (° C.) | 85 | 85 | 85 | 85 | 85 |
| | | Stretching ratio (times) | 2.4 | 2.8 | 2.4 | 2.8 | 2.8 |
| | | 1st-step relaxation: Water temp. (° C.) | 90 | 90 | 90 | 90 | 90 |
| | | Relaxation rate (%) | 11 | 11 | 11 | 11 | 11 |
| | | 2nd-step relaxation: Air temp. (° C.) | 140 | 140 | 140 | 140 | 140 |
| | | Relaxation rate (%) | 1 | 1 | 1 | 1 | 1 |
| Physical | | Outer diameter (mm) | 1.353 | 1.302 | 1.338 | 1.290 | 1.152 |
| properties | | Inner diameter (mm) | 0.834 | 0.800 | 0.804 | 0.768 | 0.660 |
| | | Thickness (mm) | 0.259 | 0.251 | 0.267 | 0.261 | 0.246 |
| | | Porosity v (%) | 78.0 | 79.3 | 77.8 | 79.4 | 77.8 |
| | | Average pore size Pm (μm) | 0.183 | 0.207 | 0.132 | 0.157 | 0.148 |
| | | Maximum pore size Pmax (μm) | 0.337 | 0.331 | 0.227 | 0.252 | 0.268 |
| | | Pmax/Pm | 1.84 | 1.60 | 1.71 | 1.61 | 1.81 |
| | | Pure-water-permeability | 106.5 | 111.7 | 58.0 | 69.8 | 64.6 |
| | | F (100 kPa, L = 200 mm) (m/day) | | | | | |
| | | Normalized water permeation rate | 95.5 | 98.6 | 52.2 | 61.5 | 58.1 |
| | | F (L = 200 mm, v = 70%) (m/day) | | | | | |
| | | Tensile force (N) | 7.7 | 7.5 | 8.8 | 7.2 | 8.4 |
| | | Tensile strength (MPa) | 8.7 | 9.1 | 9.8 | 8.5 | 12.1 |
| | | Elongation (%) | 8 | 8 | 9 | 7 | 10 |
| | | CV (%) of outer surface pore sitze | 59 | 54 | 52 | 49 | 59 |
| | | SD (μm) of outer surface pore size | 0.158 | 0.189 | 0.126 | 0.132 | 0.133 |
| | | Outer surface average pore size Ps (μm) | 0.267 | 0.350 | 0.243 | 0.270 | 0.225 |
| | | Ps/Pm | 1.46 | 1.69 | 1.84 | 1.72 | 1.52 |
| | | MBR critical water permeability (m/day) | 0.9 | 0.7 | 0.7 | 0.7 | 0.7 |
| | | Young's modulus of pre-stretching fiber (MP | 68.4 | 68.4 | 71.3 | 71.3 | 70.6 |
| | | Example | 6 | Comp. 1 | Comp. 2 | Comp. 3 | Comp. 4 |
| Starting | Mixture A | Mw of principal PVDF (×105) | 4.12 | 4.12 | 4.12 | 4.12 | 4.12 |
| material | | Mw of crystallinity-modifier PVDF (×105) | 9.36 | 9.36 | 9.36 | 9.36 | 9.36 |
| | | Mix. ratio (wt. %) | 95/5 | 95/5 | 95/5 | 95/5 | 95/5 |
| | | Mw of Mixture A (×105) | 4.38 | 4.38 | 4.38 | 4.38 | 4.38 |
| | Mixture B | Polyester plasticizer | PN150 | PN150 | PN150 | PN150 | PN150 |
| | | Solvent | NMP | NMP | NMP | NMP | NMP |
| | | Plasticizer/solvent Mix. ratio (wt. %) | 82.5/17.5 | 82.5/17.5 | 82.5/17.5 | 82.5/17.5 | 72.5/27.5 |
| | Mix. ratio | Mixture A/Mixture B (by weight ) | 37.4/62.6 | 34.4/65.6 | 34.4/65.6 | 35.7/64.3 | 35.7/64.3 |
| | Compo- | PVDF | 37.4 | 34.4 | 34.4 | 35.7 | 35.7 |
| | sition (%) | Polyester plasticizer | 51.6 | 54.1 | 54.1 | 53.0 | 46.6 |
| | | Solvent | 11.0 | 11.5 | 11.5 | 11.3 | 17.7 |
| Production | | Water bath temperature (° C.) | 65 | 70 | 70 | 40 | 48 |
| conditions | | Take-up speed (m/min) | 4.0 | 4.0 | 4.0 | 11.0 | 10.0 |
| | | Pre-stretching heat treatment | None | None | 120° C. 1 hr | 120° C. 1 hr | 120° C. 1 hr |
| | | Stretching temperature (° C.) | 85 | 65 | 65 | 60 | 80 |
| | | Stretching ratio (times) | 3.0 | 2.4 | 2.4 | 1.85 | 2.2 |
| | | 1st-step relaxation: Water temp. (° C.) | 90 | 90 | 90 | 90 | CH₂Cl₂ |
| | | Relaxation rate (%) | 11 | 17 | 17 | 8 | 5 |
| | | 2nd-step relaxation: Air temp. (° C.) | 140 | 140 | 140 | 140 | 140 |
| | | Relaxation rate (%) | 1 | 1 | 1 | 4 | 5 |
| Physical | | Outer diameter (mm) | 1.115 | 1.290 | 1.225 | 1.393 | 1.037 |
| properties | | Inner diameter (mm) | 0.628 | 0.749 | 0.715 | 0.882 | 0.584 |
| | | Thickness (mm) | 0.224 | 0.271 | 0.255 | 0.256 | 0.226 |
| | | Porosity v (%) | 77.1 | 79.2 | 76.7 | 71.0 | 73.0 |
| | | Average pore size Pm (μm) | 0.140 | 0.177 | 0.182 | 0.108 | 0.140 |
| | | Maximum pore size Pmax (μm) | 0.220 | 0.369 | 0.424 | 0.207 | 0.232 |
| | | Pmax/Pm | 1.58 | 2.08 | 2.33 | 1.92 | 1.66 |
| | | Pure-water-permeability | 57.0 | 137.0 | 162.9 | 38.4 | 83.4 |
| | | F (100 kPa, L = 200 mm) (m/day) | | | | | |
| | | Normalized water permeation rate | 51.8 | 121.2 | 148.6 | 37.9 | 80.0 |
| | | F (L = 200 mm, v = 70%) (m/day) | | | | | |
| | | Tensile force (N) | 9.0 | 7.1 | 8.1 | 9.7 | 5.7 |
| | | Tensile strength (MPa) | 13.5 | 8.2 | 10.5 | 10.6 | 9.9 |
| | | Elongation (%) | 8 | 14 | 16 | 95 | 64 |
| | | CV (%) of outer surface pore size | 61 | 71 | 77 | 69 | 74 |
| | | SD (μm) of outer surface pore size | 0.140 | 0.185 | 0.251 | 0.098 | 0.155 |
| | | Outer surface average pore size Ps (μm) | 0.230 | 0.260 | 0.326 | 0.142 | 0.210 |
| | | Ps/Pm | 1.65 | 1.47 | 1.79 | 1.32 | 1.50 |
| | | MBR critical water permeability (m/day) | 0.6 | 0.5 | 0.5 | 0.3 | 0.5 |
| | | Young's modulus of pre-stretching fiber (MP | 70.6 | 68.4 | 84.4 | 85.8 | 86.2 |

### INDUSTRIAL APPLICABILITY

As is understood from the results shown in Table 1 above, according to the present invention, there is provided a hollow-fiber porous membrane of vinylidene fluoride resin which shows not only a uniform pore size distribution as a whole but also a uniform pore size distribution on the outer surface, and also a high porosity, an excellent water-permeability maintenance power in continuous filtration of cloudy water in addition to a good pure water permeability, through a process which includes: melt-extruding a vinylidene fluoride resin together with a plasticizer and a good solvent therefor into a hollow-fiber film, cooling and solidifying the film, extracting the plasticizer and good solvent, omitting a heat-treatment for crystallization, and stretching the hollow-fiber after the extraction at a temperature of 80-95° C. which is higher than a conventional stretching temperature.

1. A hollow-fiber porous membrane of vinylidene fluoride resin, comprising a porous membrane of vinylidene fluoride resin in a hollow-fiber form; and having a ratio Pmax/Pm of at most 2.0 between a maximum pore size Pmax and an average pore size Pm, and a Pm of 0.13 μm-0.25 μm, according to the half-dry/bubble point method (ASTM F316 and ASTM E1294); a coefficient of variation in outer surface pore size of at most 70%, and a porosity of 75-90%.

2. A hollow-fiber porous membrane of vinylidene fluoride resin according to claim 1, having a pure water permeability F (100 kPa, L=200 mm) of 50-300 m/day as measured at a pressure difference of 100 kPA and a length of 200 mm.

3. A hollow-fiber porous membrane of vinylidene fluoride resin according to claim 1, having an outer surface average pore size Ps of 0.20-0.40 μm.

4. A hollow-fiber porous membrane of vinylidene fluoride resin according to claim 1, having a ratio Ps/Pm of at most 1.7 between an outer surface average pore size Ps and Pm.

5. A hollow-fiber porous membrane of vinylidene fluoride resin according to claim 1, showing a critical water permeability of at least 0.6 m/day as measured by a membrane bioreactor (MBR) process.

6. A hollow-fiber porous membrane of vinylidene fluoride resin according to claim 1, wherein the vinylidene fluoride resin has a crystallization temperature of at least 143° C.

7. A hollow-fiber porous membrane of vinylidene fluoride resin according to claim 6, wherein the vinylidene fluoride resin is a mixture of 70-98 wt. % of a principal vinylidene fluoride resin whose weight-average molecular weight (Mw) is 150,000-600,000, and 2-30 wt. % of a high-molecular weight vinylidene fluoride resin for crystallinity modification whose weight-average molecular weight (Mw) is at least 1.8 times that of the principal vinylidene fluoride resin and at most 1,200,000.

8. A process for producing a hollow-fiber porous membrane of vinylidene fluoride resin according to claim 1, comprising stretching a hollow-fiber porous membrane of vinylidene fluoride resin having a Young's modulus of at most 80 MPa under an atmosphere temperature of 80-95° C.

9. A process according to claim 8, wherein the hollow-fiber porous membrane of vinylidene fluoride resin having a Young's modulus of at most 80 MPa has been obtained by melt-extruding a vinylidene fluoride resin together with a plasticizer and a good solvent therefor into a hollow-fiber form, followed by extraction of the plasticizer good solvent, and drying.

10. A process according to claim 8, wherein the vinylidene fluoride resin has a crystallization temperature of at least 143° C.

11. A process according to claim 10, wherein the vinylidene fluoride resin is a mixture of 70-98 wt. % of a principal vinylidene fluoride resin whose weight-average molecular weight (Mw) is 150,000-600,000, and 2-30 wt. % of a high-molecular weight vinylidene fluoride resin for crystallinity modification whose weight-average molecular weight (Mw) is at least 1.8 times that of the principal vinylidene fluoride resin and at most 1,200,000.
